(19) United States
(12) Patent Application Publication
(10) Pub. No.: US 2002/0120732 A1
(43) Pub. Date: Aug. 29, 2002

(54) Open internet protocol services platform

(76) Inventors: Daniel Joseph Lee, Salt Lake City, UT (US); Connie Sue Worthington, Layton, UT (US); Cigy Cyriac, Draper, UT (US); David Maughan Atkisson, Draper, UT (US)

Correspondence Address: MORRISS, BATEMAN, O'BRYANT & COMPAGNI, 136 SOUTH MAIN STREET, SUITE 700, SALT LAKE CITY, UT, 84101, US

(21) Appl. No.: 09/963,871

(22) Filed: Sep. 25, 2001

Related U.S. Application Data
(60) Provisional application No. 60/272,279, filed on Feb. 27, 2001.

(51) Int. Cl. G06F 15/173; G06F 15/16; H04L 12/28; H04L 12/56

(52) U.S. Cl. 709/223; 709/250; 370/422

(57) ABSTRACT

A system including an Open IP Services Platform that provides any or all functions of common network devices such as routers, firewalls, packet shapers, switches, and servers in a single unit, wherein the network devices can be provided by any third party, and are interconnected through management software that enables drag-and-drop arrangement of the network devices, wherein a complete Operating System provides full functionality to the Open IP Services Platform, wherein a plurality of Open IP Services Platforms can function in a cooperative manner, and wherein a plurality of Open IP Services Platforms can form a switch fabric matrix that increases bandwidth on a local level to provide such high bandwidth services such as video-on-demand.

### CROSS REFERENCE TO RELATED APPLICATIONS

This document claims priority to, and incorporates by reference all of the subject matter included in the provisional patent application filed Feb. 27, 2001, entitled OPEN INTERNET PROTOCOL SERVICES PLATFORM AND TOPOLOGY FOR USE.

### BACKGROUND

1. The Field Of The Invention

This invention relates generally to the creation of open Internet Protocol (IP) management tools and services. Specifically, the present invention is a network tool that integrates and performs the functions of multiple network related services in an Open IP Services Platform, wherein these services are typically performed by discrete components.

2. Background of the Invention

Access to the Internet or other global information networks is generally becoming a commodity as Service Providers (SPs) and Local Exchange Carriers (LECS) look to new value-added applications and services in order to retain customers, attract new business clients, and generate revenue. Enterprises face a limited supply of certified network administrators, increased demand for high-bandwidth network services, and the need to reduce the total cost of ownership while preserving existing infrastructure investments.

Unfortunately, existing solutions for SPs and LECs fall short in a number of important areas. For example, most customer-premise equipment (CPE) is not Telco quality, thus resulting in inconsistent, unreliable service and problematic service agreements. Next, integration between network devices from a variety of vendors is difficult at best. Furthermore, a lack of extensibility and flexibility makes CPE difficult to scale. New application services can require a large upgrade, or at least a visit to the customer to modify or replace equipment. There are almost always new costs associated with every new piece of Internet Protocol (IP) functionality, as well as additional management issues. Finally, each piece of equipment requires a separate management interface, preventing network-wide visibility.

The issues above all combine to prevent delivery of revenue-generating, differentiated IP services to an increasingly demanding customer base.

Current network designs typically require a discrete piece of equipment for each network function to be performed. For example, an Enterprise will typically include network devices that interface with desktop computers and servers, and connect them to the Internet or other network. The network devices includes servers, switches, routers, bridges, firewalls, load balancers, packet shapers, etc. Managing this wide conglomeration of network devices requires a significant amount of time and vendor-specific expertise.

As network requirements expand and change, the need for specialized network services also changes. For example, repositioning a single network device within a network architecture disadvantageously necessitates both network downtime and a physical presence to make the changes. It is useful to examine a typical network configuration for an Enterprise to better understand the problem.

FIG. 1 is an illustration of a typical network topology 10 of the prior art. The interface between desktops 12 and servers 14 to a network, such as the Internet 16, typically includes network devices or components such as a router 18, a firewall 20, a packet shaper 22, and at least one switch, but where two switches 24, 26 are shown in this figure. Another server 28 might also be part of this interface, when the server is providing network services such as in an SQL server, DNS server, Web server, etc.

Each of the discrete components listed above is disposed within its own “box.” Each box occupies a certain amount of space, or footprint. Furthermore, each box must also have its own power supply.

It would be an advantage over the state of the art to provide network administrators with a network architecture and system tools that would provide a consolidated, flexible, scalable, and less complex management solution that can be customized according to a customer's needs. Such a solution should enable network components, both the hardware and the software, to be included from any vendor. It would also be an advantage to decrease the level of complexity of the solution such that management tasks can be performed by a person with limited computer network and vendor-specific knowledge.

In order to assist the network administrator, it would also be an advantage to provide a plurality of pre-configured or “canned” network configurations. Thus, for relatively simple network configurations, the administrator would not even have to design the network topology, as long as the available network components matched the canned network configuration.

It would also be an advantage over the prior art to provide a solution where the network configuration can be modified on the fly. The system should also be capable of enabling control of the system, if desired, down to single network port control, or sophisticated enough to manage all of the network ports as determined by network conditions.

It would also be an advantage to provide a plurality of these systems such that they can be coupled together in a large network, be it the Internet, or a more localized WAN or LAN topology. The system should also enable spare processing capability to be made available for other applications, without degradation of the network functions being performed.

It would also be an advantage to provide third parties with the ability to have greater control of how their plug-in hardware or software operates with the invention by enabling programming of ActiveX modules that enable components to be dragged and dropped in a control and management interface into desired network configurations.

Security of state of the art network devices is also a problem because embedded devices typically utilize a modified version of operating system software. The modified version is typically scaled down so as to include limited features. Therefore, it would be an advantage over the prior art to provide a system that utilizes a complete Operating System that can take advantage of the full range of Operating System's capabilities, including security features.

### SUMMARY OF THE INVENTION

It is an object of the present invention to provide a system that enables multiple network functions to be performed within a single device.

It is another object to provide the system wherein a single unit can perform any combination of the functions of a router, bridge, load balancer, firewall, packet shaper, switch, server, or any other network devices.

It is another object to provide the system wherein the interconnections between the functions can be modified through software.

It is another object to provide the system wherein the interconnections can be modified without taking the network down to make the changes.

It is another object to provide the system wherein a complete Operating System is utilized to thereby take advantage of all the security features that are available.

The present invention is embodied in a system comprising an Open IP Services Platform that provides any combination of functions of common network devices such as routers, bridges, firewalls, packet shapers, switches, load balancers, and servers in a single device, wherein the network devices can be provided by any third party, and are interconnected to function as a network through management software that enables drag-and-drop configuration of the network devices, wherein configuration of the network is performed through software control and not physical rearrangement, and wherein a complete Operating System provides full functionality to the Open IP Services Platform.

These and other objects, features, advantages and alternative aspects of the present invention will become apparent to those skilled in the art from a consideration of the following detailed description taken in combination with the accompanying drawings.

### DESCRIPTION OF THE DRAWINGS

FIG. 1 is a block diagram of a typical network topology of the prior art.

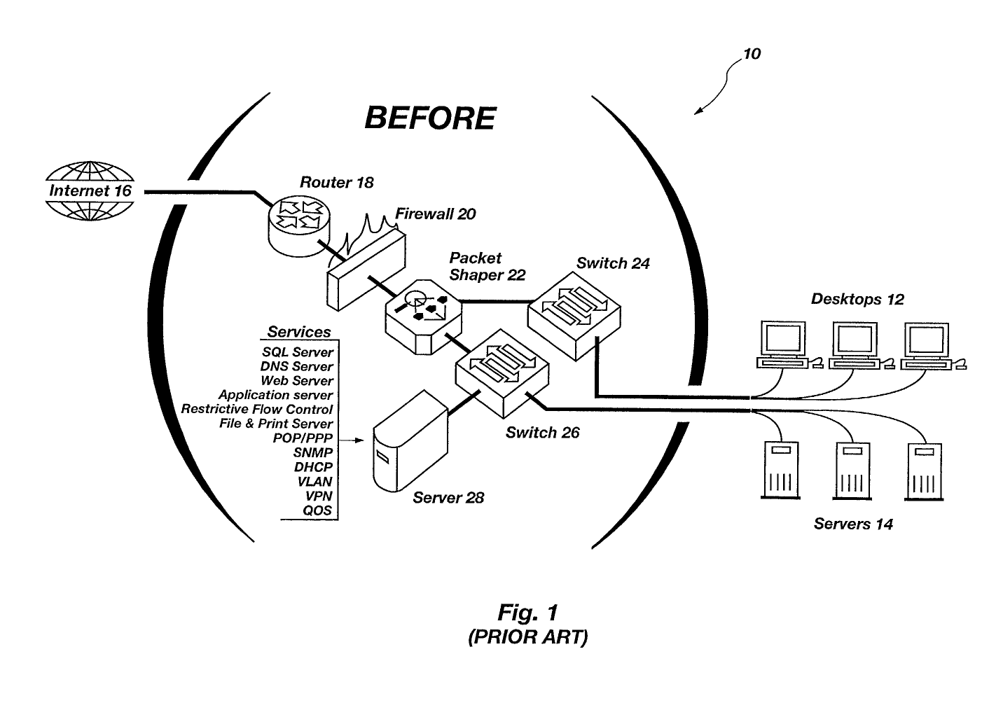

FIG. 2 is a block diagram that is made in accordance with the principles of the presently preferred embodiment.

FIG. 3 is a block diagram that explains how the Open IP Services Platform 30 incorporates a Level 4 switch router at the bottom level, and a general purpose central processing unit (CPU) 34 at the top level.

FIG. 4 is a block diagram that is provided to give greater detail to the configuration of the Open IP Services Platform.

FIG. 5 is a block diagram of the software architecture of the present invention.

FIG. 6 is a block diagram that illustrates the relationship between virtual NICs and the virtual interconnect.

### DETAILED DESCRIPTION

Reference will now be made to the details of the invention in which the various elements of the present invention will be described and discussed so as to enable one skilled in the art to make and use the invention. It is to be understood that the following description is only exemplary of the principles of the present invention, and should not be viewed as narrowing the claims which follow.

The present invention encompasses a range of improvements that by themselves and in combination are novel inventions. The fundamental building block of the invention is a new type of network device (hereinafter referred to as the “Open IP Services Platform”). The Open IP Services Platform is capable of functions that are found in no other device. To understand the advantages of this Open IP Services Platform, it is helpful to name a few network devices, and explain how their functions are all performed by the present invention.

Typical network components include but are not limited to routers, bridges, firewalls, packet shapers, switches, load balancers, and servers. These devices can all be found on a first side of the router, wherein on the second side, the router functions as a gateway to networks such as LAN segments, WANs, and the Internet or other global information networks. The specific topology of these networks on the first side of the router can vary significantly depending upon the needs and functions of the local network segment. Thus, several of the problems that the present invention overcomes include 1) the total number of physical devices that may be required for a network, 2) the number of wires that must be installed between the devices, 3the time required to configure the devices, 4) the level of knowledge of the person that is installing the devices, 5) an understanding and memory of the specific topology that has been set up, and 6) the ability to reconfigure a topology on-the-fly.

The presently preferred embodiment of the invention is able to overcome these problems for several reasons. First, all of the network devices can be physically disposed within a single unit, or Open IP Services Platform. Obviously, there are many obstacles that must be overcome to do this. For example, the Open IP Services Platform of the present invention is constructed to accept network components from third parties. In other words, it is not a feature of the present invention to provide these network components, rather it is an aspect of the invention to provide a device that can house them in the Open IP Services Platform. Not only can these network components be disposed within the Open IP Services Platform, but more than one type of network component can be housed together. Essentially, all of the network components listed previously can be housed within a single unit of the Open IP Services Platform.

In order to dispose these network components together so that they function, several novel elements of the present invention had to be developed. A first aspect was a system for configuring the interconnections between the network components in the Open IP Services Platform. Consider multiple switches and a packet shaper disposed within the Open IP Services Platform. The packet shaper must be coupled to specific ports of the multiple switches. It is a novel aspect of the invention to provide a software package COREVISTA WEB™ that provides configuration control by physically interconnecting network devices that are stored within the Open IP Services Platform. Control is provided at what can be considered to be two levels. The first level of control enables the user to make specific port assignments if the system administrator is experienced, while the second level of control takes specific port assignments out of the hands of the administrator, and allows the specific configuration of ports to be left to the configuration software if the system administrator has only a limited understanding of network topology.

It should be mentioned that the software package for configuration and management of the device is simple enough to operate that a network specialist does not have to be brought in to set up the Open IP Services Platform.

This aspect of the invention is made possible because the interface provides drag-and-drop configuration, as well as pre-configured loads.

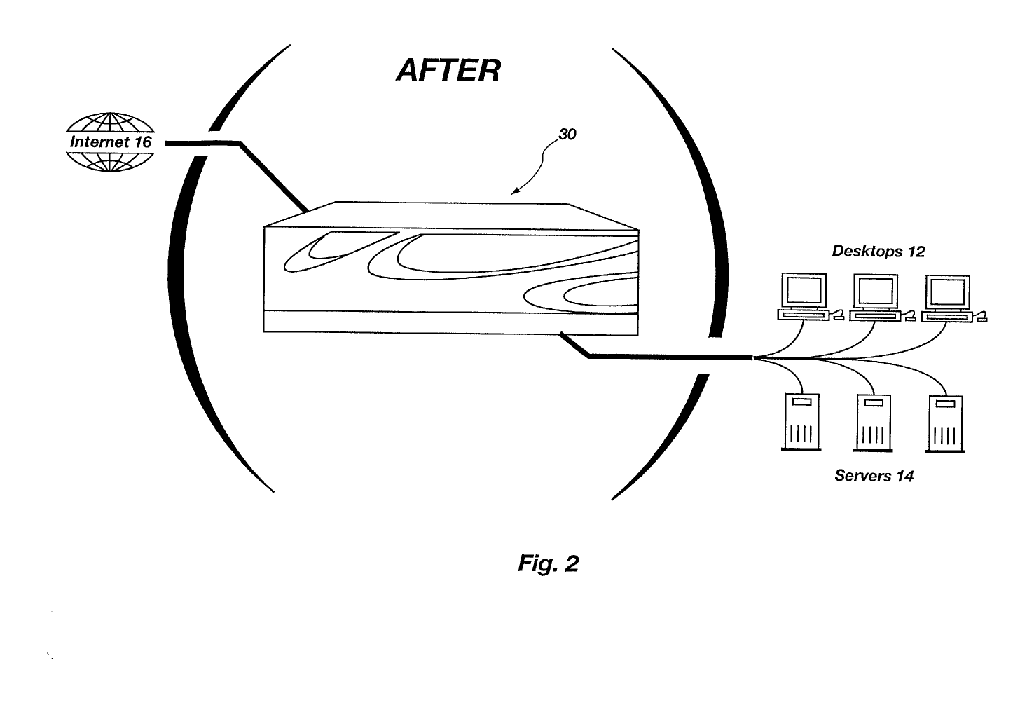

With this brief introduction, the presently preferred embodiment of the invention is shown in FIG. 2. FIG. 2 illustrates that all of the network services provided by individual network components 18, 20, 22, 24, 26, 28 have been replaced by a single Open IP Services Platform 30. It should be remembered that any or all of the functions of the network devices described above can be replaced as desired.

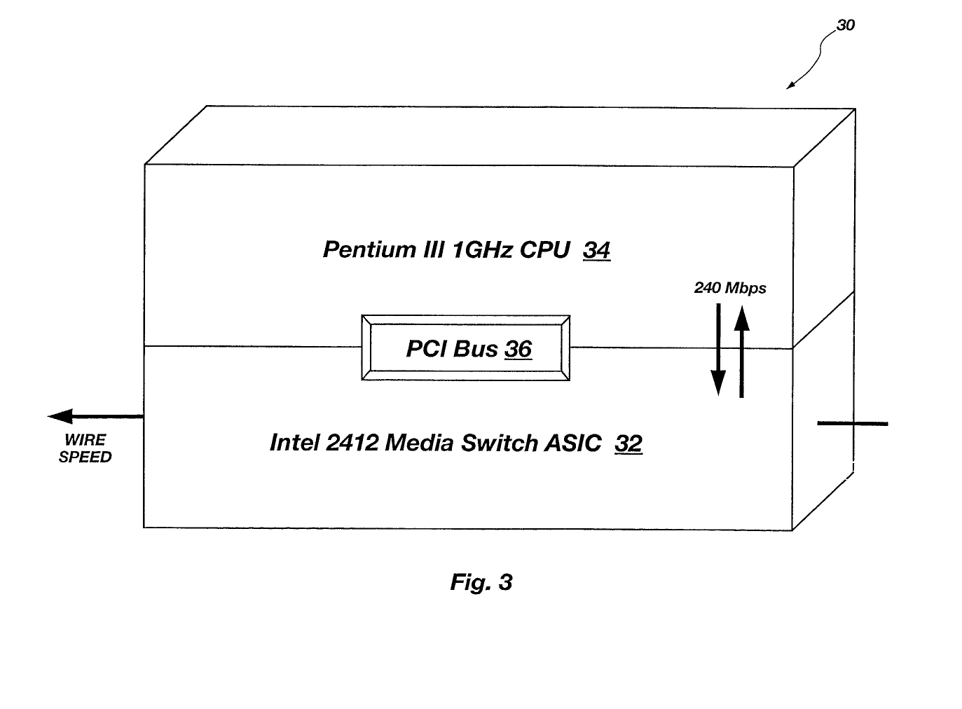

FIG. 3 is a block diagram of the presently preferred embodiment of the present invention. This figure is provided to illustrate that the Open IP Services Platform 30 incorporates a Level 4 switch router 32 at the bottom level, and a general purpose central processing unit (CPU) 34 at the top level. It should be mentioned that while a general purpose CPU is preferred, any type of specialty CPU can be substituted. The reason for preferring a general purpose CPU is that it is going to be more flexible. In other words, the Open IP Services Platform 30 can do more than just function as a unit for consolidating network functions if it is given more processing power and ability to run more programs. These other capabilities are addressed in a simultaneously filed application. The drawback is that a specialty CPU can be faster. However, given the fact that general purpose CPUs have increased in operation capabilities so rapidly, it is unlikely that the CPU would be a bottleneck to performance for most situations where the Open IP Services Platform is deployed.

The switch router 32 communicates with the CPU 34 via an internal Peripheral Component Interconnect (PCI) bus 36. Presently, that translates into a communication conduit of 240 Mbps between those components 34, 36. However, the switch router 32 is communicating at wire speed with network components in levels 2-4.

It is noted that it would take an OC-3 connection to the Internet for the input to the Open IP Services Platform 30 to exceed the processing throughput capabilities of the CPU used in the preferred embodiment. The OC-3 type of connection is uncommon to most businesses, and thus the present invention is going to handle almost all connection scenarios without becoming a bottleneck.

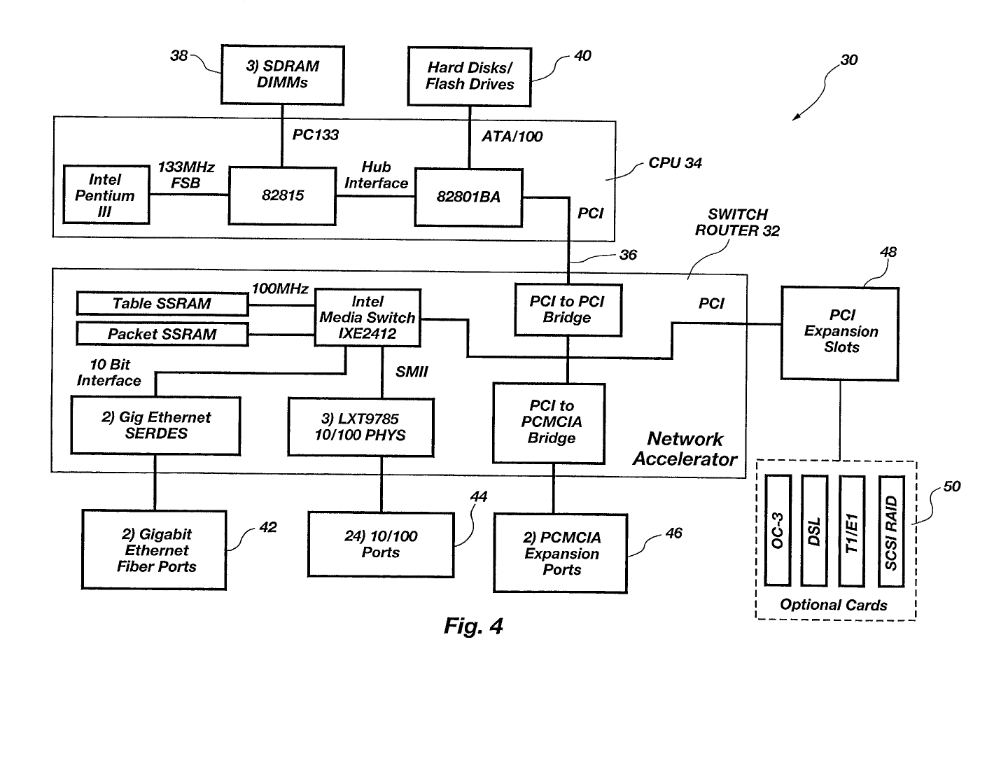

FIG. 4 is a block diagram that is provided to give greater detail to the configuration of the Open IP Services Platform 30. The CPU 34 is preferably a single board computer (SBC) operating with an INTEL™ chipset. The preferred microprocessor for the SBC 34 is an INTEL™ PENTIUM™ III. The SBC 34 communicates with memory in the form of SDRAM DIMMs 38, and possibly an array of hard drives/flash drives 40. The hard drives/flash drives 40 are optional, depending upon the needs of the network or of the network components being incorporated into the Open IP Services Platform 30, as will be explained.

The switch router 32 is shown coupled to the SBC 34 via the PCI bus 36. The switch router 32 has also been labeled as a network accelerator to more fully describe its function. The switch router 32 is shown as providing the port connections to external networks via the Gigabit Ethernet Fiber (GBIC) Ports 42, 10/100 Mbps Ethernet (Base T) Ports 44, PCMCIA Expansion Ports 46, and additional PCI Expansion Slots 48.

The PCI Expansion Slots 48 are designed to receive the hardware of the network function being installed. In other words, a third party network function card is installed in one of the PCI Expansion Slots 48, enabling the Open IP Services Platform 30 to function as a load balancer, a firewall, etc.

It is also noted that optional cards 50 can also be installed into the PCI Expansion Slots 48. These optional cards can include such functions as OC-3, DSL modem, T1/E1 termination, and SCSI RAID. Thus it is seen that the Open IP Services Platform 30 is not fixed in its configuration or its function.

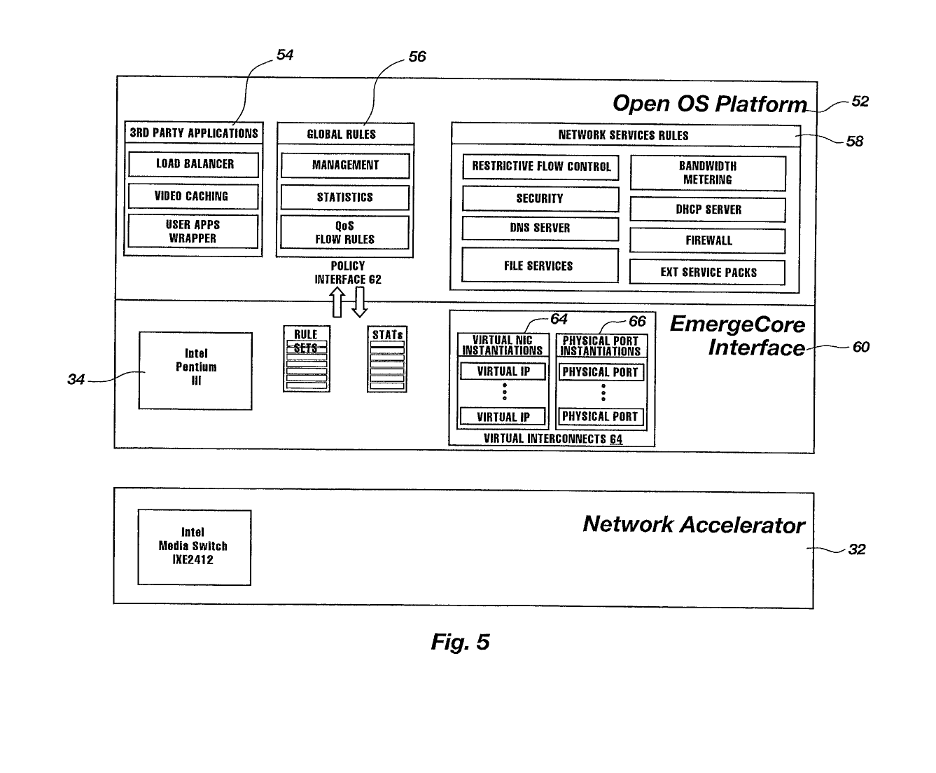

FIG. 5 is a block diagram of the software architecture of the present invention. The Operating System 52 is preferably one that has an open architecture. This selection of an open architecture OS was made so that the system administrator is given the ability to modify the operating system itself, if necessary, in order to obtain the desired operation of the invention, without having to depend on others to provide the desired capabilities.

Another advantage of utilizing an open architecture OS is that some users will want to drop their own software into the Open IP Services Platform 30. Unfortunately, this flexibility also enables users to write code that can potentially interfere with the other functions in the Open IP Services Platform 30. Advantageously, the complete OS provides memory management that prevents third party software from jeopardizing the operation of any other network functions taking place.

The Open IP Services Platform 30 is also operated by a multi-tasking operation system. In the presently preferred embodiment, a stable and secure OS is desired. The Open IP Services Platform 30 is currently operated using FreeBSD or Linux. It is also important to understand that the OS operation within the Open IP Services Platform 30 is not what is typically referred to as an embedded OS. An embedded OS is often a smaller and less capable version of the complete OS. The present invention utilizes the complete OS so that all capabilities of the OS are available. These capabilities include the all-important security features.

The Operating System 52 executes third party applications 54, with the global rules 56 including management, statistics, and Quality of Service flow rules, and network services rules 58. Network service rules 58 include restrictive flow control, security, a DNS server, file services, bandwidth metering, a DHCP server, a firewall, and external service packs.

The Operating System 52 communicates with the interface 60 of the SBC 34. This communication is controlled via policy interface 62. Virtual interconnects 64 handle the translation within the SBC 34 of mapping virtual NIC instantiations 66 to physical port instantiations 66.

Presently, the invention includes two different system configurations, the ECREACTOR 3000™ and the ECREACTOR 5000™. There are several common features in these products including: two Gigabit GBIC Ports 42, twenty four 10/100 (Base T) Ports 44, a single 733 MHZ PENTIUM™ III CPU 34 that is ungradable, 32 MB of RAM and 32 MB of Flash RAM 38, both ungradable, two USB ports, one serial port that is optional, and two PC card slots 46, type 2. The devices are different in that there are two PCI bus slots, and an optional hard drive on the ECREACTOR 3000™. In contrast, the ECREACTOR 5000™ includes four PCI bus slots, and comes with two RAID bays for up to 6 hard drives, and a redundant power supply. Both systems are configurable via local PC, serial port, modem, or via a network connection. More control is possible, however, using a configuration program that operates in the WINDOWS™ environment.

It is observed that presently both systems run FreeBSD 4.2 and Linux Kernel 2.2.17 (RedHat 6.2 or 7.0, Mandrake 6.2) Operating Systems. However, a PC running any Operating System can communicate with them via Telnet or a command line interface. But the software configuration tool, COREVISTA WEB™, is currently a WINDOWS™ application.

Other important statistics of the systems are that the address table size is 16K IP and 8K IPX addresses with no per port limits, and more available via aging.

The systems also include an RS-232 console port that supports remote monitoring and diagnostics via a DB-9 (DTE) connector. Pre-set configurations include, but are not limited to, internal and external T1, DSL modem, analog modem, and others. A store-and-forward forwarding mode is available. Filtering modes are destination-based, multicast address-based, or port based. 1K virtual LAN support is also provided.

Upgrades to the Open IP Services Platform 30 are also available using the FTP protocol via Flash PROM. Additional features include port priority, port aggregation (multi-link), port mirroring for RMON probes, and link aggregation and redundancy where up to 8 ports can be configured as a single 800 Mbit link.

When considering how the present invention is different from the state of the art, the present invention hooks the networking functions into a server to make network functions more seamless. In other words, instead of just operating as a Network Interface Card (NIC) tied into a switch or router, the present invention provides full control over the switch and router functions. This approach is different from the state of the art because no one has previously tried to provide this type of interface that enables a third party to load their own components into a box providing some type of network function. In fact, this approach is antithetical to the business model of any other network function provider. For it is the desire of suppliers of network functions that the user not try to add hardware or software components of a third party into their own box. Obviously, this type of approach severely limits trying to build a “best of class” network if a user can only install certain brands of products when interoperability is a must.

Thus, the present invention performs the unique function of being an integrator of network products that have previously required separate boxes or isolated operation in order to function. Advantageously, the present invention does not have to try and provide any of the network functions themselves, but instead provides a box that enables network cards performing all manner of functions to be disposed therein, while providing the hardware and software to make interconnections between the different network cards. Thus, even though the present invention does provide switch/router capabilities, even these functions can be replaced or enhanced by the addition a third party switch or router card.

Another way to look at the invention is seen by examining its use of virtual NICs. Using virtual NICs, in the sense that they present a standard interface like a normal driver, up to the services and stacks above it in the software, so that the software believes it is communicating with a normal driver. A novel aspect of the invention is to be able to dynamically remap it to other services within the Open IP Services Platform. This means the data does not have to serialized/deserialized. This also gives the present invention the ability to remap to physical ports down through the bottom end of a networking stack. Another advantage is the ability to create rules based on a specific interface. Thus, the use of virtual NICs provides the invention with the ability to map process to process.

Another use of the virtual NICs has to do with memory allocation. Typically, a pool of memory resides with the driver. Memory is handed off to other resources as needed. Memory, in this case a buffer, is eventually released and given back to a driver. An important aspect of the invention is to share all of the buffers across all of the virtual NICs.

For example, consider a packet of data received by a router installed in the Open IP Services Platform. The router would had down a tag or pointer for data stored in a buffer to a virtual NIC interface, which would hand the tag to a firewall. Thus, the data in a buffer is no longer being transferred or copied from buffer to buffer as each new process receives the data in the buffer, but instead the data remains in the same buffer, and control of the tag to the buffer is what is passed from process to process. Thus, the Open IP Services Platform becomes very fast and very efficient in its handling of packets because the present invention utilizes the virtual NICs or virtual interconnect that handles buffer data management across the services, rather than individually. Thus, buffer management is done globally, but handled at a low level. Thus, the allocation of memory in the buffer pool is known at all times because buffer management is being handled globally.

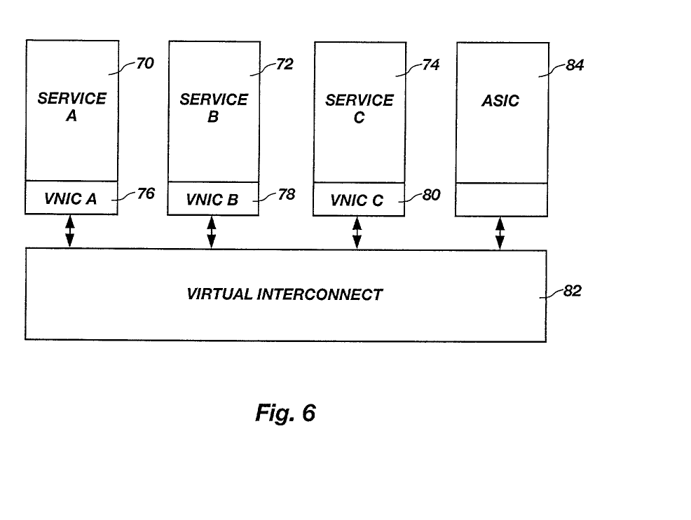

To help understand the aspects of the invention described above, FIG. 6 is provided to show how virtual NICs (VNICS) are utilized. FIG. 6 shows three services, A 70, B 72, and C 74. A VNIC is shown coupled to each of the services, thus providing VNIC A 76, VNIC B 78, and VNIC C 80. Each of the VNICs is coupled to the virtual interconnect 82 of the Open IP Services Platform 30. The services 70, 72, and 74 pass pointers or tags to data stored in a global managed memory buffer. By having the VNICs A 76, B 78 and C 80 pass pointers or tags to each other instead of having to actually copy the data in the buffers, overhead is reduced. The ASIC 84 is shown to explain that the services can be broadly defined. It is noted that the virtual interconnect 82 can be controlled by rules that are user defined. The rules determine what data can be passed to particular services. The virtual interconnect 82 is also responsible for packet redirection, or in other words, passing of pointers to the data in the buffer from one service to another service. The virtual interconnect 82 can also perform multicast copying and management. The virtual interconnect 82 becomes a flow mechanism among software instead of a serialization/deserialization process. The virtual interconnect 82 is both software and routing between stacks on the same processor, and it is also hardware in that the hardware interconnections are configured between ports.

The virtual interconnect 82 is one of the aspects of the invention that makes it possible to add multiple functions to a single processor, but also to work in the opposite direction. In other words, a single service can be spread out across multiple processors. Thus, when a processor determines that it does not have enough processing power available for a particular service, a portion of the services can be redirected at wire speed to another processor.

An interesting use of this virtual NIC technology is utilizing it with VLANs. Not only is it possible to control ports on a port by port basis, the present invention enables control on a virtual port basis out through VLANs. Thus, a port in the Open IP Services Platform can be assigned to a group of services that do not even have to be present in the Open IP Services Platform. For example, consider two Open IP Services Platforms coupled together. The services in a first Open IP Services Platform can be assigned to a port in a second Open IP Services Platform. The present invention has thus added the ability to hook a driver into an application that maps to an outside port. This is done using the tagged VLAN mechanism.***

Another aspect of the invention to consider is the combining of a server and switch. By doing so, the server has full access to all the data because the server has all of the protocols. Thus, the switch becomes a full router, with the ability to process and manipulate the data. Consider the advantage of being able to serve data immediately to a port so that the network itself does not become a bottleneck. For example, a typical network infrastructure limits speed of data to the 100 Mbit or 1 Gbit data pipes. But by merging the server and the switch together, data now moves at the speed of the bus in the server, which can be much greater. Furthermore, providing multiple system buses within the server provides the function of scalability by using the Open IP Services Platform 30.

One of the novel aspects of the invention is that because the present invention is not trying to duplicate the functions of a proprietary firewall, call it Firewall A, there are no licensing fees to be paid because Firewall A is purchased and put into the Open IP Services Platform 30. The Open IP Services Platform 30 thus provides all of the functionality of Firewall A because it is the actual Firewall A. Likewise, Load Balancer B is manufactured by a different company, is purchased, and disposed within the Open IP Services Platform 30 next to Firewall A. Firewall A and Load Balancer B now provide all of their functionality in a single box. All interconnections between them are provide by the present invention down to a port-by-port basis.

Another novel aspect of the invention is that it prevents exclusivity of function. Suppose that the manufacturer of Firewall A enters into an exclusive contract such that it is no longer available for use in the Open IP Services Platform 30. Advantageously, Firewall A is removed and Firewall B is put in its slot. After loading Firewall B's drivers, it is likely that no other configuration of Firewall B will be required. The firewall functions will operate as before.

It is another aspect of the invention that most network functions can be added into the Open IP Services Platform 30 without modification. The only requirement is that the driver for the network function be provided for the OS that is running on the Open IP Services Platform 30.

Another aspect of the invention is that the Open IP Services Platform 30 can communicate at wire speed with other Open IP Services Platforms. This is advantageous when, for example, a particular function is not being performed fast enough in one particular unit. Just one function can be rerouted at wire speed to another Open IP Services Platform 30.

Consider an Open IP Services Platform 30 that is performing the functions of a server that is providing FTP, web services, mail services, etc. It is possible to assign any of the services to different servers (Open IP Services Platforms 30), at wire speed, to keep performance at a desired level. The present invention can also reconfigure the Open IP Services Platform 30 on the fly such that when certain performance bottlenecks are being reached, the Open IP Services Platform 30 will reassign functions as previously defined by the administrator.

Another feature of the present invention is that both configurations of the Open IP Services Platform 30 provide keyboard, mouse, and monitor ports. Thus, the Open IP Services Platform 30 is a full-fledged server that a developer can work on directly.

It is observed that the physical dimensions of the Open IP Services Platform 30 are also industry standard for use in data centers and other facilities that use rack mounted equipment. The dimensions vary from a 1U-high to a 3U-high unit that are rack-mountable.

Another novel aspect of the invention that increases versatility is the type of environments in which the Open IP Services Platform 30 can operate. Small businesses are often stashing network components into closets or other tight spaces. This closed environment typically runs hotter than a room with its own thermostat. Accordingly, the Open IP Services Platform 30 would normally run at a higher than optimal temperature. Another aspect of the invention is to provide a solid state refrigeration unit. This aspect is especially important when considering the commercial and industrial locations where the Open IP Services Platform 30 will be used. This is also more important for the ECREACTOR 5000™ model that includes hard drives. Hard drives are especially vulnerable to high operating temperatures. The refrigeration unit can be disposed just on the hard drives themselves.

With these features in mind, it is useful to consider the manner in which the present invention utilizes them to achieve novel advantages, while observing that the advantages are available to all of the targeted core markets of SPs, LECs and Enterprises. First, the invention provides a consolidated equipment solution. Managing a wide array of single-function, multi-vendor network devices creates high installation and management costs. The present invention consolidates the many functions performed by the individual network devices. The equipment consolidation can be partial or total, with a single device replacing entire racks of physical equipment. Consolidation of network functions solves a critical long-term build-out problem in Enterprise IT rooms, SP data centers, and in LEC central offices where equipment proliferation often overwhelms available power, air conditioning or physical space limitations. Consolidated equipment means that there are fewer interconnections, fewer cables, and fewer moving parts to fail, resulting in increased uptime and reduced ongoing support costs.

Consolidated network equipment greatly simplifies installation and ongoing maintenance. The present invention includes an elegant, intuitive, centralized management application, COREVISTA WEB™, that enables installation in less than 15 minutes. Thus, the administrator can deploy units without needing to complete multiple, vendor-specific, certified training programs as will be explained. The present invention even offers self-configuring features on base units.

The flexible allocation of network resources is made possible because software is used to make all connections between network devices installed in the present invention. Any single or combination of virtual or physical ports can be instantly reassigned new IP services on a port-by-port basis. This enables the administrator to reconfigure IP services as needs change, and without taking down any part of the network. This aspect is especially critical to large Enterprises, and almost any SP and LEC.

One of the greatest advantages of the present invention is the use of open IP standards. Proprietary technologies are often initially attractive because lower costs can be achieved for a specific function. Disadvantageously, however, proprietary technologies often limit selection of complementary equipment, leaving the network function isolated and unexpandable. Additionally, proprietary equipment can preclude the use of certain IP services completely, and can require an administrator to provide specialized training for staff. Thus, hidden costs add up and quickly surpass any initial savings.

The present invention delivers a truly open architecture communications platform specifically designed to enable rapid deployment of “best in class” applications and value-added services for mission-critical communications, while preserving existing infrastructure. The present invention also enables the administrator to offer any IP service through the Enterprise, SP or LEC.

Configuring the Open IP Services Platform 30 can be performed in various ways. To drag and drop icons representing the network components requires that the administrator access the Open IP Services Platform using the COREVISTA WEB™ configuration program. In contrast, access over the web using COREVISTA WEB™ enables the administrator to configure what is already loaded in the Open IP Services Platform 30, but not to design the layout. In other words, it enables the administrator to configure what is already loaded, but not change the layout.

When performing configuration over a network, it is noted that SSH is provided for a secure and encrypted configuration session.

One useful feature is that the configuration can be stored on and loaded from a PC card. Thus, if an SP or LEC needs twenty identical Open IP Services Platforms 30, only one has to be manually configured using the COREVISTA WEB™ configuration program. The configuration is then stored on a PC card that can be duplicated. The administrator then only has to insert the PC card into a non-configured Open IP Services Platform 30, and load the configuration.

Both the ECREACTOR 3000™ and the ECREACTOR 5000™ Open IP Services Platforms include a host of standard software applications right out of the box. These software applications include an APACHE™ web server, SQL™-based database management, various drivers and interface for the ports and other hardware, DHCP, IPB4 router, network access translation (NAT), a restrictive flow packet shaper, SNMP, point to point protocol (PPP), a virtual private network (VPN), a virtual LAN (VLAN), SSH tunneling. Some Open IP Services Platforms can also include a SAMBA server, DNS, a POP mail server, and full software or hardware RAID functionality.

The present invention also provides a standardized interface to all of the network cards that can be loaded. This interface is SQL-based to enable full control over access to the network functions. It is also a function of the invention to provide ActiveX modules for each network function that is being added. The power of this feature is that, for example, the ActiveX module can be input to a spreadsheet. As the network is operating, the spreadsheet is displaying all of the statistics of that network function in realtime.

One of the advantages of the present invention that may not yet be apparent is that it includes a central point of configuration control. Each network card has an associated database and ActiveX component. Thus, two firewalls can be configured in exactly the same way. Obviously, each firewall card requires its own unique driver and instruction set because they are probably proprietary systems. Surprisingly, both of the firewall cards can be controlled using the identical ActiveX component and the same database. The present invention is able to provide a centralized, standard interface program that performs the translation between the database and the firewall cards themselves.

It was stated previously that the present invention provides allocation of network resources at the port, protocol, and IP address level. In other words, it is possible to control and thus sell IP services on a port-by-port basis. It is useful to examine several examples of how this works.

Consider an office building with four tenants, A, B, C and D. In a packet shaper that comes with the ECREACTOR 3000™, each of the tenants can be allocated Internet access by a rule set, trigger point, or manually. Rule sets are used to allocate resources. For example, the tenants can share a T1 line equally, where each tenant is restricted to 300 kb of bandwidth. A trigger point is used to activate particular rule sets, depending upon the conditions. Finally, it is possible to manually override the rule sets and trigger points.

A first example is when none of the tenants are restricted to the amount of bandwidth that they can use. Therefore, tenant A may use 800 kb of bandwidth without interfering with the other tenants. Then, tenants B, C, and D all need 200 kb of bandwidth. At this point, the bandwidth of the T1 is exceeded. A trigger point can be set so that when bandwidth demand exceeds the maximum available bandwidth, the tenants are restricted. The rule set that is activated can divide all the bandwidth equally, or still favor the heaviest bandwidth user while reducing the bandwidth to that user.

Bandwidth can also be allocated according to the type of activity that is being performed. Thus, activity can be restricted based on protocol, or the type of activity that is occurring. Thus, all tenants can be given unrestricted flow control on e-mail, but restricted flow on web browsing or FTP.

It was mentioned that flow control can be managed down to a single port. For example, there can be three ports, each port having a unique firewall and flow control configuration.

Another feature of the present invention when rules and trigger points are useful is when access is suddenly restricted to the Open IP Services Platform 30 itself. For example, a cable in the ground is cut by some construction activity. The Open IP Services Platform 30 can reconfigure itself based on the total available bandwidth that it sees. Thus, when a T1 line is cut, and the dial-up access becomes the only way to get out on the Internet, all users may be severely restricted, and yet enable vital services such as email. However, access to web servers behind the Open IP Services Platform 30 from the outside may have to be eliminated to ensure email access.

Not only can access to outside networks be dynamically allocated, but it is also possible to perform access metering. Thus, if a tenant desires to be charged only for actual use of access to an outside network, this can be done.

It is important to realize that the scenarios described above are available only because all of the network functions are disposed within a single box that can reconfigure itself on the fly.

The specification above is specifically addressed to the novel aspects of the hardware and software integration of third party network cards. However, it is mentioned that the COREVISTA WEB™ is also considered a novel aspect of the invention, as is the unique database structure that enables the configuration software to function with and configure all the third party network cards that are disposed within the Open IP Services Platform 30. However, all of the functionality of these other novel aspects of the invention are not required for the invention to function. What is important is that a common SQL database structure be provided that enables each network function to be controlled thereby. Regarding the configuration software, it is only necessary that each network function be controlled by an ActiveX module that is linked to an SQL database. Thus, a consistent interface to the actual network cards is provided. Furthermore, third parties can develop and deliver their own ActiveX module for their network component.

By assigning each ActiveX module to its own SQL database, each network component is able to have its own password to its functionality. Therefore, an administrator can have a unique password for each network component, thereby allowing access to specific modules without compromising the entire network configuration.

The other advantage of SQL databases is that each module can be controlled by a set of rules. These rules can be manually triggered, or automatically triggered by an event. The events can be time-based or triggered by network conditions. Likewise, bandwidth usage can be restricted when the demands outstrip the available supply. These events can even trigger a call for help to a system administrator or to another designated party.

This flexibility in control of the aspects of the Open IP Services Platform enable unprecedented opportunities. For example, a business can provide Internet access to any other business in a building, thus operating as a mini-Internet Service Provider (ISP). Bandwidth can be dolled out in any desired increments to users. The bandwidth can even be controlled down to the port on a switch.

It is to be understood that the above-described arrangements are only illustrative of the application of the principles of the present invention. Numerous modifications and alternative arrangements may be devised by those skilled in the art without departing from the spirit and scope of the present invention. The appended claims are intended to cover such modifications and arrangements.

What is claimed is:

1. A method for integrating the functions of at least two network services in an Open IP Services Platform that provides access to a network, said method comprising the steps of:
1) providing a single board computer running an open architecture Operation System, at least two bus connectors coupled to the single board computer, and used for receiving cards that perform network functions, a switch/router board coupled to the single board computer, and a plurality of network ports coupled to the switch/router board; and
2) configuring interconnections between the at least two bus connectors, the switch/router board, and the single board computer by utilizing configuration software that directs a plurality of switches to make physical interconnections within the Open IP Services Platform.

2. The method as defined in claim 1 wherein the method further comprises the step of enabling the Open IP Services Platform to determine a desirable network topology within the Open IP Services Platform for the at least two network functions being performed.

3. The method as defined in claim 2 wherein the method further comprises the step of enabling an administrator to utilize the configuration software to configure individual ports of the Open IP Services Platform.

4. The method as defined in claim 3 wherein the configuration software is able to configure the individual ports of the Open IP Services Platform by selecting a configuration scheme from the group of configuration schemes comprising bandwidth usage, rule sets, trigger points, IP services being performed, and protocol usage.

5. The method as defined in claim 4 wherein the configuration software enables on the fly configuration of the Open IP Services Platform, wherein the Open IP Services Platform is not rebooted in order to effect desired changes in interconnections.

6. The method as defined in claim 5 wherein the method further comprises the step of enabling a plurality of different network devices to be coupled to the at least two bus connectors, wherein the plurality of different network devices are selected from the group of network devices comprising routers, switches, load balancers, bridges, firewalls, packet shapers, and servers.

7. The method as defined in claim 6 wherein the method further comprises the step of enabling network devices from any vendor to be included in the Open IP Services Platform, wherein memory management prevents any one of the network devices from interfering with operation of any other network device.

8. The method as defined in claim 7 wherein the method further comprises the step of enabling any vendor of the network devices to provide a software module that is utilized by the configuration software to represent and control operation of a network device.

9. The method as defined in claim 8 wherein the method further comprises the step of providing the Operating System that includes all components of a complete version, thereby including all security and memory management features.

10. The method as defined in claim 9 wherein the method further comprises the step of modifying or making additions to the Operating System in order to enable a network device to operate within the Open IP Services Platform.

11. The method as defined in claim 10 wherein the method further comprises the step of reducing the time required to configure the network topology, wherein the configuration software provides a graphical user interface that enables an administrator to drag and drop icons representing the network devices into the desired network topology.

12. The method as defined in claim 11 wherein the method further comprises the steps of:
1) providing a plurality of pre-configured network topologies that are stored in memory;
2) selecting of the pre-configured network topologies; and
3) instruction the Open IP Services Platform to implement the network topology defined in the pre-configured network topology utilizing network devices installed in the Open IP Services Platform.

13. The method as defined in claim 11 wherein the method further comprises the step of reducing networking knowledge requirements of the administrator, to thereby facilitate rapid and easy deployment of the network topology.

14. The method as defined in claim 13 wherein the method further comprises the step of enabling operation of the Open IP Services Platform in harsh environments that would otherwise preclude operation of the Open IP Services Platform by providing localized cooling for specific temperature sensitive components.

15. A method for providing an Open IP Services Platform that is capable of performing various network functions according to the specific network components that are disposed therein, and according to a network topology selected for those network components, said method comprising the steps of:
1) providing a single board computer running an open architecture Operation System, at least two bus connectors coupled to the single board computer, and used for receiving cards that perform network functions, a switch/router board coupled to the single board computer, and a plurality of network ports coupled to the switch/router board;
2) coupling a first set of network devices to the at least two connector buses; and
3) configuring interconnections between the first set of network devices, the switch/router board, and the single board computer to thereby define a first network function and a first network topology for the Open IP Services Platform.

16. The method as defined in claim 15 wherein the method further comprises the steps of reconfiguring through configuration software the interconnections between the first set of network devices, the switch/router board, and the single board computer to thereby define a second network function and a second network topology for the Open IP Services Platform, without having to change the first set of network devices.

17. The method as defined in claim 16 wherein the method further comprises the steps of:
1) removing the first set of network devices from the Open IP Services Platform;
2) coupling a second set of network devices to the at least two connector buses; and
3) configuring interconnections between the second set of network devices, the switch/router board, and the single board computer to thereby define a third network function and a third network topology for the Open IP Services Platform.

18. A method for integrating the functions of a plurality of network devices into a single Open IP Services Platform that provides access to a network, to thereby reduce space requirements and the number of wires used to interconnect network devices, said method comprising the steps of:
1) providing a single board computer running an open architecture Operation System, at least two bus connectors coupled to the single board computer, and used for receiving cards that perform network functions, a switch/router board coupled to the single board computer, and a plurality of network ports coupled to the switch/router board;
2) coupling a network device to one of the at least two bus connectors, and
3) configuring interconnections between the network device, the switch/router board, and the single board computer by utilizing configuration software that directs a plurality of switches to make physical interconnections within the Open IP Services Platform, thereby eliminating external wires normally used to interconnect the network device and the switch/router board.

19. A system including an Open Internet Protocol (IP) services platform for integrating the functions of at least two network services in a single unit that does not require external wires to couple the at least two network services together, said system comprising:
a single board computer (SBC), including memory;
an open architecture Operating System (OS) stored in the memory;
at least two bus connectors for receiving cards that perform network functions, wherein the at least two bus connectors are coupled to the SBC;
a switch/router board coupled to the single board computer;
a plurality of network ports, wherein the plurality of network ports are coupled on a first side to the switch/router board, and provide a connection to a network on a second side thereof; and
configuration software for controlling interconnections between the at least two bus connectors, the switch/router board, and the SBC.

20. The system as defined in claim 19 wherein the open architecture Operating System is selected from the group of Operating Systems comprised of FreeBSD and Linux.

21. The system as defined in claim 20 wherein the at least two bus connectors further comprise peripheral component interconnect (PCI) bus connectors.

22. The system as defined in claim 21 wherein the switch/router board is further comprised of:
a PCI to PCI bus bridge;
a PCI to PCMCIA bus bridge;
at least one random access memory module; and
a media switch for performing switch and router function.

23. The system as defined in claim 22 wherein the plurality of network ports further comprises:
at least two gigabit ethernet ports;
at least twelve 10/100 ethernet ports; and
at least two PCMCIA type 2 expansion ports.

24. The system as defined in claim 23 wherein the plurality of network ports further comprises at least one universal serial bus (USB) port.

25. The system as defined in claim 24 wherein the at least two PCI bus connectors are coupled to network card performing network functions, wherein the network functions are selected from the group of network functions comprising routers, switches, load balancers, bridges, firewalls, packet shapers, and servers.

26. The system as defined in claim 25 wherein the SBC further comprises a microprocessor that is selected from the group of microprocessors comprised of general purpose microprocessors and special purpose microprocessors.

27. The system as defined in claim 26 wherein the configuration software further comprises a software utility that enables drag-and-drop configuration of network components, to thereby simplify configuration of network components within the Open IP Services Platform.

28. The system as defined in claim 27 wherein the configuration software utilizes icons that are representative of the network components, wherein the icons are ActiveX modules that define the functions that are performed by the network components.

29. The system as defined in claim 28 wherein the switch/router board is a level 4 network device that is capable of communicating with other Open IP Services Platforms at wire speed.

30. The system as defined in claim 29 wherein the system further comprises a solid state refrigeration unit, where the refrigeration unit is disposed directly on a case of a hard drive, thereby directing cooling efforts directly on the most temperature sensitive device within the Open IP Services Platform.
